(19) United States
(12) Patent Application Publication
(10) Pub. No.: US 2003/0041962 A1
(43) Pub. Date: Mar. 6, 2003

(54) Digitally printed products and process

(76) Inventors: John R. Johnson, Valparaiso, IN (US); Jerry Roedel, Cedar Lake, IN (US)

Correspondence Address: CHRISTIE, PARKER & HALE, LLP, 350 WEST COLORADO BOULEVARD, SUITE 500, PASADENA, CA, 91105, US

(21) Appl. No.: 09/947,077

(22) Filed: Sep. 5, 2001

(51) Int. Cl. B32B 31/00

(52) U.S. Cl. 156/266

(57) ABSTRACT

A process for manufacturing three-dimensionally shaped polymeric sheets and laminates with color-matched digitally printed full color ink jet images. A flexible thermoformable polymeric baseweb is placed in an ink jet printer and a solvent-based (non-aqueous) digital printing ink is applied directly to the baseweb, in the absence of an ink receptive layer on the baseweb, to form a decorative pattern in multiple colors in a single pass through the printer. The finished product can be thermoformed or injection molded to a three-dimensional shape. A protective topcoat can be laminated to the digitally printed sheet prior to the thermoforming and/or injection molding step. A process for making color-matched products comprises producing a software-driven image of a pattern on a screen representing a standard color print pattern; evaluating and adjusting the standard displayed on the screen using software-driven image related adjustments for hue, contrast, lightness/darkness, etc.; producing a test print by applying a decorative pattern to the baseweb by a digital ink jet printer and making optional software-driven image-related adjustments in the test print to color match the test print image to the standard; and when the adjusted test print image is acceptable, passing an image-related output to the digital ink jet printer for printing a decorative print color-matched to the accepted onscreen standard.

### FIELD OF THE INVENTION

This invention relates to ink jet printing of color images on polymeric sheets and laminates, and more particularly to the manufacture of three-dimensionally shaped polymeric sheets and laminates with color-matched digitally printed full color ink jet images.

### BACKGROUND OF THE INVENTION

Three-dimensionally shaped polymeric sheets and laminates are commonly printed with full color decorative print patterns. The printed sheets or laminates can be bonded to an injection molded substrate to make the finished part. These products can include interior automotive parts such as dashboard parts and gauges with decorative finishes, including decorative wood grain, and other products such as cell phones, personal electronic equipment (MP3 and CD players), EMI/RFI shielding, signs, and outdoor siding panels, for example.

These products are commonly made by a gravure printing process in which color separations in individual layers are initially sent to an engraver and produced on gravure plates. Inks are produced for individual color layers, and a composite is made to duplicate the customer's color sample. When the colors are acceptable, these steps are repeated to produce production gravure cylinders. The composite is then color-matched on a gravure press, and when the color match is acceptable, the gravure cylinders print the finished pattern. The substrate can comprise a polymeric sheet printed with several passes through the gravure press to produce the various color elements of the finished design. The sheet then can be laminated to a substrate and thermoformed and/or injection molded to a finished three-dimensional shape.

Digital printing allows use of computer generated and enhanced images. This can provide substantial design and production advantages over gravure printing. Computer generated images can be stored and instantly produced from computer memory. This also allows multiple designs to be printed at the same time, whereas with gravure printing, each separate design print must be made in the multi-step process described above.

### SUMMARY OF THE INVENTION

The present invention provides a process for making ink jet printed products such as thermoformable polymeric sheets and laminates with color-matched digitally printed full color ink jet images.

In one embodiment, the invention comprises a process for making a thermoformable laminate which includes a flexible thermoformable polymeric sheet or film, also referred to herein as a baseweb. The baseweb is placed in an ink jet printer and a solvent-based (non-aqueous) digital printing ink is applied directly to the baseweb, in the absence of an ink receptive layer on the baseweb, to form a digitally printed decorative ink jet pattern in multiple colors with good ink adhesion in a single pass through the printer. This is followed by thermoforming and/or molding the finished printed baseweb into a three-dimensional shape. In a separate embodiment of the invention, the print pattern on the baseweb can be protected by a laminated transparent protective polymeric topcoat. In another embodiment, the digital printing can be directly applied to the underside of a clear coat layer to form a decorative pattern on the clear coat layer in multiple colors in a single pass through the printer.

Another embodiment of the invention comprises a process for making a color-matched thermoformable decorative laminate. The process includes producing a software-driven image of a pattern on a screen to represent a standard color print pattern, and evaluating and adjusting the standard as displayed on the screen using software-driven image-related adjustments for hue, contrast, lightness/darkness, saturation, resolution and image size, for example. A test print is then produced by the steps of applying a decorative pattern to a thermoformable polymeric sheet or film (baseweb), using a digital ink jet printer. Adjustments are made to the test print image to color-match the test print to the accepted standard as displayed on the screen. When the adjusted color-matched test print image is acceptable, an image-related output is passed to the digital ink jet printer for digitally printing on a baseweb a decorative print color-matched to the accepted on-screen standard.

Compared with gravure printing, the digital printing process of this invention speeds the color-matching processing and the process of producing multiple color images. The invention also provides high quality digitally printed images on three-dimensionally shaped parts in which the applied ink jet images have good print quality, abrasion resistance and adhesion to the substrate. The invention also provides digitally printed laminates having a protective outer layer having exterior grade long-term weatherability, durability, and optical properties such as high gloss. Printing directly on the baseweb provides substantial cost savings. Another advantage is that one can see what the product looks like immediately after it is printed. With gravure printing, on the other hand, a sample is taken off-line and laminated to a baseweb piece, which slows the color matching process.

Digitally printed images can be applied to selected areas such as the exact patterns corresponding to the thermoformed parts, whereas with gravure printing, the entire width of the baseweb must be printed with printed scrap areas between the thermoformed parts. There can also be substantial cost saving advantages in production by eliminating the need for lengthy lacquer production and color qualifying time.

These and other aspects of the invention will be more fully understood by referring to the following detailed description and the accompanying drawings.

### BRIEF DESCRIPTION OF THE DRAWINGS

FIG. 1 is a flow chart showing a prior art process for making gravure printed products.

FIG. 2 is a schematic cross-section illustrating a digitally printed laminate with a protective topcoat according to principles of this invention.

FIG. 3 is a schematic cross-section illustrating a digitally printed laminate in which a print layer is applied directly to the backing sheet.

FIG. 4 is a schematic cross-section illustrating a digitally printed translucent laminate.

FIG. 5 is a schematic cross-section illustrating a laminate in which a digitally printed clear topcoat is overlaminated on a separate laminate comprising a clear coat/color coat/backing sheet combination.

FIG. 6 is a schematic flow diagram illustrating steps in a digital color adjustment process.

FIG. 7 is a schematic flow diagram illustrating a process for producing a digitally printed substrate.

FIG. 8 is a schematic flow diagram illustrating a digitally printed laminate produced by printing on a protective base web laminated to a backing sheet.

FIG. 9 is a schematic flow diagram illustrating a digitally printed product produced by printing directly on a clear substrate.

FIG. 10 is a schematic cross-section illustrating a laminate having a digitally printed layer with a metallized layer.

FIG. 11 is a schematic cross-section illustrating a laminate having a digitally printed layer applied to a PVC backing sheet having a pressure-sensitive adhesive layer.

FIG. 12 is a schematic cross-section illustrating a laminate having an optically clear protective coat, with a print layer, an opaque backing sheet, and an EMI/RFI shielding layer.

FIG. 13 is a schematic cross-section illustrating a laminate in which a print layer is applied between a low gloss PVDF/acrylic protective coat and a rigid PVC backing sheet.

FIG. 14 is a schematic cross-section illustrating a reverse printed clear laminate with a clear topcoat.

FIG. 15 is a schematic cross-section illustrating a thick sheet laminate with a digitally printed layer.

FIG. 16 is a schematic cross-section illustrating a laminate in which a protective clear coat is applied with an ink jet printer, along with a digitally printed layer.

FIG. 17 is a schematic cross-section illustrating a digitally printed laminate comprising an in-mold film.

### DETAILED DESCRIPTION

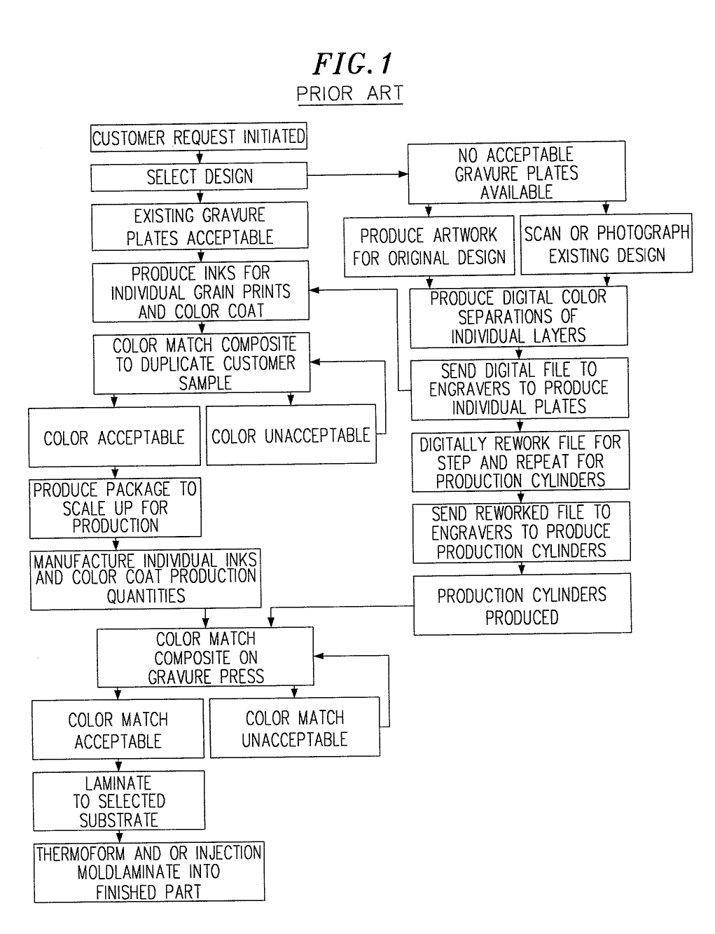

The present invention provides a process for making digitally printed products in which multiple color decorative print patterns are applied to a polymeric sheet or laminate by a digitally-controlled ink jet printer. The polymeric sheet or laminate comprises a thermoformable material in the form of a flexible film or sheet or a semirigid sheet (each of which is referred to herein as a baseweb) on which a decorative image is digitally printed. Digital printing of this invention allows the use of computer generated and enhanced images. The finished product is characterized by color-matched digitally printed full color ink jet images. The invention provides substantial design and production advantages over gravure printing. To that end, the invention may be more fully appreciated by initially referring to the schematic flow diagram of FIG. 1 which illustrates a typical prior art gravure printing process. According to this process, the selected design is tested for acceptable color separations using engraved gravure plates. If existing gravure plates are not available, color separations in individual layers are first sent to an engraver and produced as individual layers on individual gravure plates. Inks are produced for individual color layers and a composite is made from the gravure plates and color-matched to duplicate the customer's design sample. When a color match is acceptable these steps are repeated to produce production gravure cylinders. The composite is then color-matched on a gravure press and when the color match is acceptable the gravure cylinders print the finished pattern. If gravure plates were not initially available, digital reworking is involved in producing the production gravure cylinders. The baseweb can comprise a polymeric sheet or film printed with several passes through the gravure press to produce the various color elements of the finished design. The sheet or film then can be laminated to a substrate and thermoformed and/or injection molded to a finished three dimensional shape.

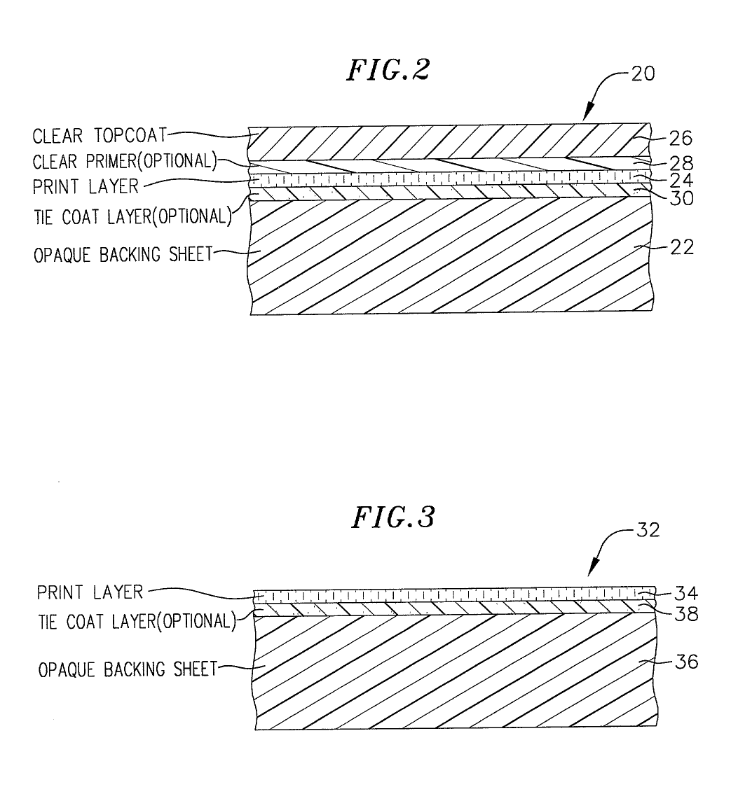

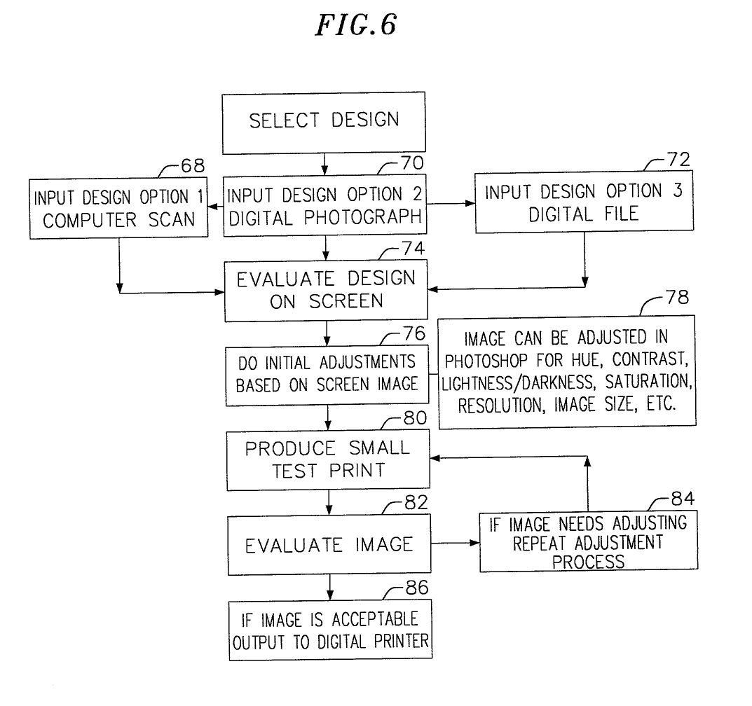

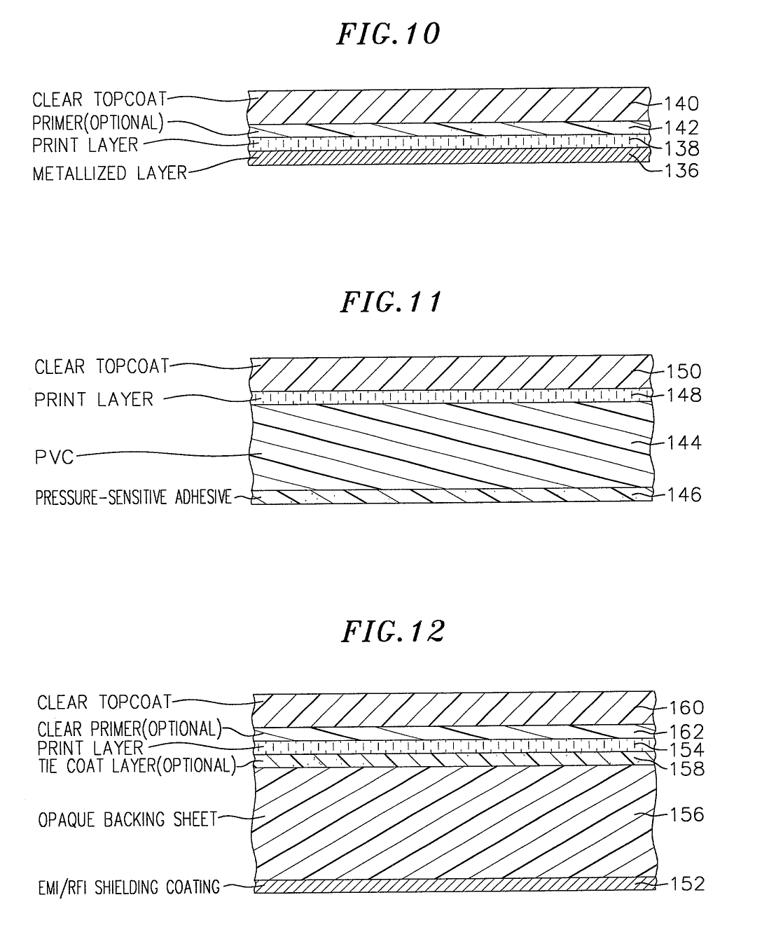

FIGS. 2-5 illustrate various constructions of digitally printed products made according to principles of this invention. Other constructions are described later and illustrated in FIGS. 10-16. FIGS. 6-9 are schematic block diagrams illustrating various processing techniques for making the digitally printed products of this invention.

Generally speaking, the different constructions comprise various combinations of polymeric sheets or films (basewebs) to which a print layer is applied. The print layer refers specifically to digital printing, preferably ink jet printing. In one embodiment, there are from four to six color cartridges in the digital printer. The color in each cartridge is kept constant. A software program controls how these set colors are combined to produce an image. Printing can be directly applied to the polymeric baseweb, which is preferably a flexible thermoformable polymeric material capable of being transported through an ink jet printer to receive the digitally controlled multiple color ink layers from the ink jet head. In one embodiment, organic solvent based (non-aqueous) digital printing ink is applied to a baseweb surface having an absence of an ink receptive layer. The digital printing inks are generally vinyl and acrylic resinous materials. The polymeric sheet or film has sufficient flexibility that it can be unwound from a supply roll, passed through the printer, and stored on a take-up roll. Machine adjustments to the digital printer can be made to adapt to printing on different polymeric baseweb materials. These machine adjustments include drying time (speed of baseweb), printing speed and heating the baseweb. A forced air or infrared dryer can be used for heating the baseweb before and after printing, to improve ink adhesion and to dry the printed ink pattern.

In a presently preferred embodiment of the invention the polymeric sheet or film (baseweb) on which the printing is applied is from about 0.5 to about 40 mils in thickness. The baseweb can be a thermoformable semirigid backing sheet which has sufficient flexibility to be transported through the ink jet printer; or the baseweb can comprise a thin flexible film usually supported by a flexible temporary carrier sheet. The semirigid sheets are generally about 10 to about 40 mils in thickness. Opaque polymeric sheets or films can include ABS, TPO, polycarbonate, acrylic and urethane. Optically clear sheets or films can include polycarbonate, PETG, acrylic and urethane. Thin polymeric films used as a baseweb can include PVC, PVDF/acrylic and urethane resins. These films are typically from about 0.5 to about three mils in thickness. These films can be supported by a temporary carrier sheet, such as PET, during printing.

The digitally printed products may include a protective topcoat having weatherability and durability properties sufficient for protecting the underlying construction. The protective topcoat is a weatherable, exterior grade durable, optically clear polymeric material, which is also preferably thermoformable. Presently preferred materials comprise PVDF/acrylic, PVC, urethane and acrylic resins. The PVDF/acrylic topcoat preferably has a 63/37 ratio of solids content and is available under the designation AVLOY from Avery Dennison Corporation.

A clear primer may be necessary to adequately bond the print layer to various topcoats. Acrylic resins are commonly used for the primer coat. A tie coat layer also may be applied to a polymeric sheet or film to bond the print layer to the sheet or film. Tie coat materials can include acrylic resins for ABS, and a two-layered tie coat for TPO which includes a CPO (chlorinated polyolefin) that contacts the TPO and an acrylic resin that contacts the print layer. As described below, the print layer can be applied to a transparent protective topcoat layer in some constructions.

Printing inks useful in this invention include (1) 3M Scotchcal Piezo Ink Jet Ink Series 3700, (2) Roland FPG Series and CR-MR2 Series cartridges, and (3) Inkware (division of Vutek) printing ink. Ink jet printers useful for carrying out the invention include (1) Scitex “Novo Green,” (2) Vutek “Ultra Vu 3360” and “Ultra Vu 2360 SC,” (3) Roland “Hi-Fi Jet Pro,” and (4) “Arizona” printer from Raster Graphics.

The Roland printer uses the Roland printing inks and the 3M printing inks. The Vutek printer uses the Inkware inks. The Scitex printer uses its own brand of inks. Organic solvent-based inks with pigments have produced superior weathering results. Failures were produced under similar conditions with water-based inks that contained dyes.

Referring now to the various constructions of digitally printed products which illustrate principles of this invention, FIG. 2 illustrates a laminate 20 which includes a semirigid thermoformable polymeric backing sheet 22 having a protected print layer 24. A semirigid backing sheet according to this invention has a thickness from about 10 to about 40 mils. A baseweb in this thickness range is thermoformable to a desired three-dimensional shape. The print layer can be applied directly to the underside of an optically clear topcoat 26 which is then laminated to the backing sheet; or the print layer can be applied directly to the backing sheet with the clear topcoat applied as an overlaminate. When printing the topcoat layer, a temporary carrier film is used to support the thinner topcoat layer which may have a thickness from about 0.5 to about three mils. An optional optically clear primer 28 may be used to bond the print layer to the topcoat; or an optional tie coat layer 30 may be applied to the backing sheet to bond the print layer to the backing sheet.

FIG. 3 illustrates a digitally printed laminate 32 without a protective topcoat. In this embodiment a print layer 34 is applied directly to a semirigid thermoformable opaque polymeric backing sheet 36. The print layer, according to this invention, can be applied directly to the backing sheet in the absence of a separate ink receptive layer on the backing sheet. In some instances the ink layer has sufficient adhesion to the backing sheet and sufficient abrasion resistance to produce a commercial product in the absence of an ink receptive layer or a protective topcoat. However, if the backing sheet comprises TPO, an optional tie coat layer 38 may be used for bonding the print layer to the backing sheet. This construction may be useful for cell phones, MP3 and CD players and other personal electronic equipment. Performance requirements are typically lower for these types of products compared to interior or exterior automotive parts for which the construction of FIG. 2 would be more useful.

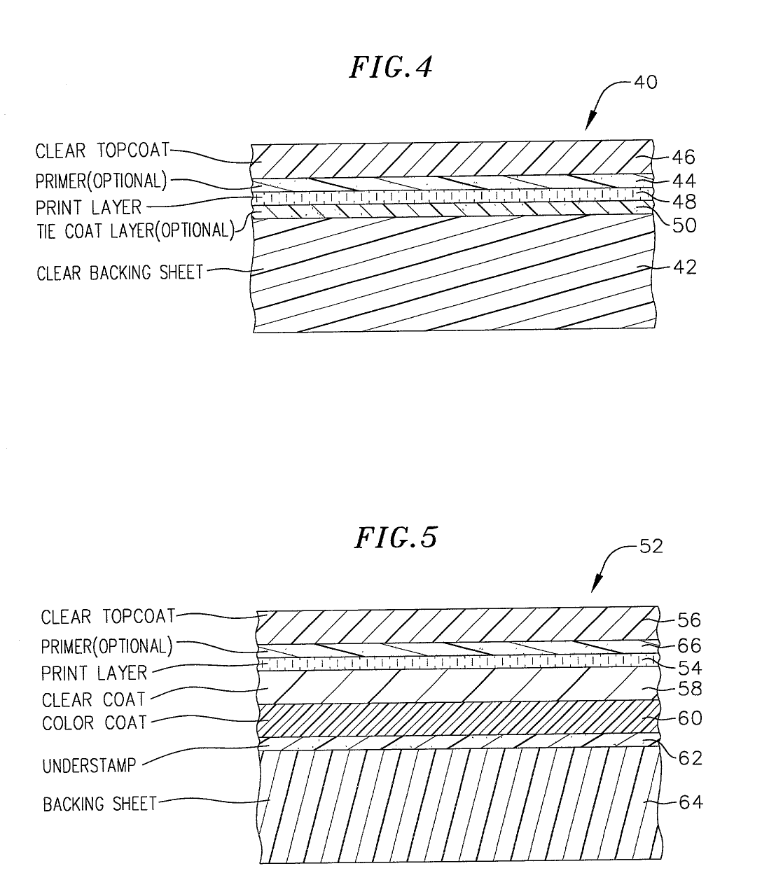

FIG. 4 illustrates a construction similar to FIG. 2 in which a translucent laminate 40 comprises an optically clear semirigid polymeric backing sheet 42 having a print layer 48 protected by a clear topcoat 46. An optional primer coat 44 and an optional tie coat 50 can be used in a manner similar to the FIG. 2 construction. The print layer is sufficiently translucent to allow visible light through the laminate. For lower performance requirements, the laminate of FIG. 4 can be made without the protective topcoat.

FIG. 5 illustrates a clear overlaminate 52 having a print layer 54. This construction includes a clear topcoat 56 which has been printed with the print layer 54. The topcoat is supported by a temporary carrier during printing and is laminated to a preexisting laminate which includes an optically clear coat 58, an underlying pigmented color coat 60, and an adhesive layer or size coat (understamp) 62 on a semirigid polymeric backing sheet 64. The clear topcoat may include an optional primer coat 66 for bonding to the print layer.

The embodiments of FIGS. 2 through 5 provide digitally printed laminates which are thermoformable to a desired shape while substantially retaining their initial optical characteristics (gloss, DOI), print quality and adhesion of the print layer to the baseweb.

FIGS. 6 through 9 illustrate various processing steps in color-matching and producing the digitally printed laminates of this invention. FIG. 6 illustrates a digital color adjustment process which involves scanning an image, making color adjustments, and producing small test prints for use in evaluating the image. The process starts with selecting a design, preferably one made by a multiple color process such as a common four-color process, although ink cartridges greater in number than four can be used. The selected design originates from several input design options which include a computer scan 68, a digital photograph 70 or a digital file 72. A software-driven image of a pattern is displayed on a computer screen 74 to represent a standard color print pattern. The standard is evaluated and adjusted on the screen using software-driven image-related adjustments for hue, contrast, lightness/darkness, saturation, resolution, image size, etc. These steps are illustrated at 76 and 78. The software typically assumes that the color layers are applied to a white print background. A small test print 80 is produced using a software program such as Photoshop. The test print is made by the steps of applying a decorative pattern to a polymeric baseweb using digital printing ink applied by a digital ink jet printer. Adjustments are made to the test print image to color-match the test print to the accepted standard as displayed on the screen. The standard as displayed on the screen is not adjusted once the color-matching process starts. When the adjusted, color-matched test print image output from the printer is acceptable, an image-related output is passed to the digital ink jet printer for digitally printing on the baseweb to produce a decorative print color-matched to the accepted on-screen standard. The image evaluation step is illustrated at 82, the adjustment process at 84, and the output of the acceptable image to the digital printer is illustrated at 86.

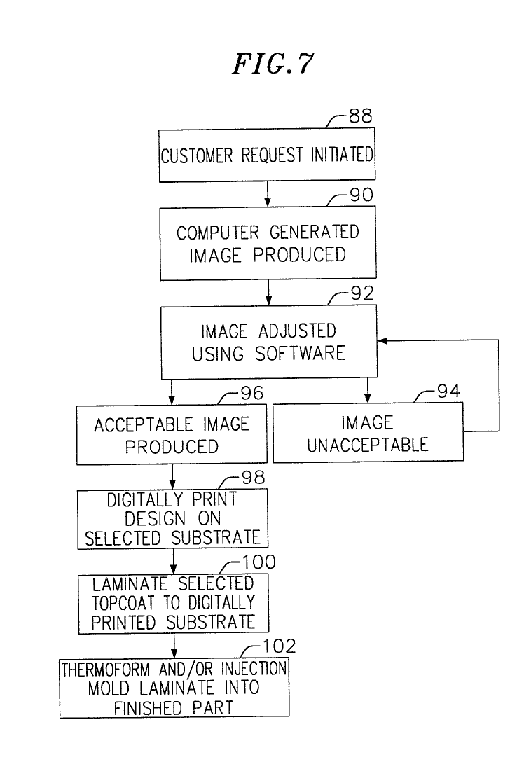

FIG. 7 is a flow diagram illustrating a process for making digitally printed products produced by printing directly on a substrate. According to this process, a customer request 88 is initiated, a computer-generated image is produced 90, and the image is adjusted on a computer screen 92 using a software-driven computer program 92. Unacceptable images are adjusted at 94 using the software for making the adjustments until an acceptable image 96 is produced on the computer screen. The acceptable design is digitally printed on a selected substrate 98 and a selected topcoat is laminated to the digitally printed substrate 100. The resulting laminate is then thermoformed and/or injection molded into the finished part 102.

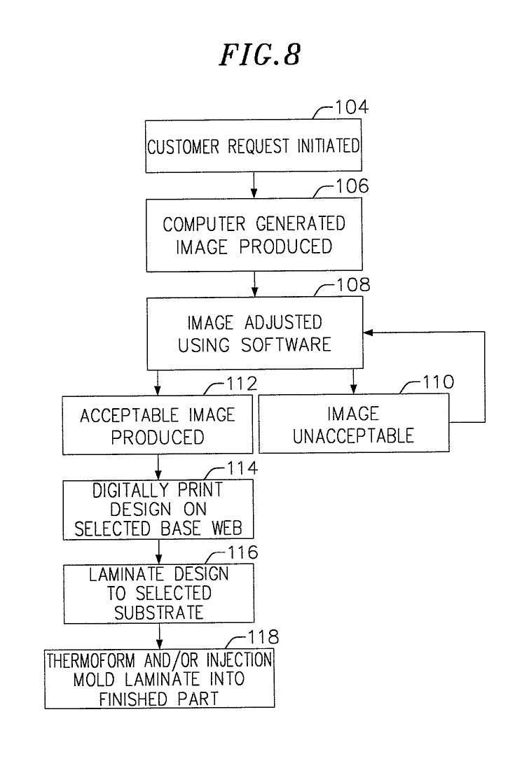

FIG. 8 is a flow chart illustrating a digitally printed product produced by printing on a protected baseweb which is laminated to the backing sheet. This process includes initiating a customer request 104, computer-generating the image 106, adjusting the image using a software-driven computer program 108, adjusting images which are unacceptable on the computer screen to make image adjustments 110, and when an acceptable image is produced at 112, the acceptable design is digitally printed on a selected baseweb 114. The design is laminated to a selected substrate 116, and the laminate is then thermoformed and/or injection molded into the finished part 118.

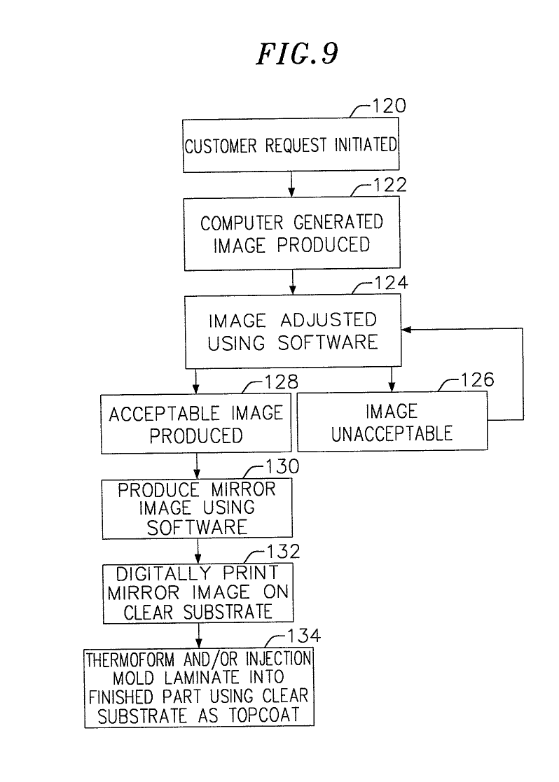

FIG. 9 is a flow chart illustrating a process for making a digitally printed product produced by printing directly on a clear substrate. In this process a customer request is initiated 120, a computer generated image 122 is produced, the image is adjusted using the software program 124, and unacceptable images on the computer screen are adjusted using the software 126 until an acceptable image 128 is produced. A mirror image is produced using software 130 and the mirror image is digitally printed on a clear substrate 132. The finished laminate is then thermoformed and/or injection molded into a finished part 134 using the clear substrate as a topcoat.

FIG. 10 illustrates a digitally printed laminate which includes a metallized layer 136. A print layer 138 is printed on the underside of a clear topcoat 140 supported by a temporary carrier during printing. An optional primer coat 142 may be used for bonding the print layer to the clear coat. The metallized layer is applied after printing. The resulting product can be later laminated to a backing sheet. The metallized layer can be vacuum metallized or contain an effect pigment such as high aspect ratio metal flakes.

FIG. 11 illustrates a digitally printed laminate which includes a PVC backing sheet 144 having a pressure-sensitive adhesive layer 146. A print layer 148 is printed directly on the PVC layer. The topcoat is then laminated to the printed side of the PVC sheet on the side opposite from the pressure-sensitive adhesive layer.

FIG. 12 illustrates a digitally printed laminate which includes an EMI/RFI shielding layer 152. This construction includes a print layer 154 which is printed directly on an opaque backing sheet 156, although the print layer can optionally be printed on a tie coat layer 158 for bonding it to the backing sheet. A clear topcoat 160 cast on a temporary carrier is overlaminated to the print layer side of the backing sheet. A clear primer 162 can be optionally used for bonding to the print layer. The EMI/RFI coating can be applied digitally, but also can be applied by gravure or reverse-roll coating. In an alternative embodiment, the EMI/RFI shielding coating can be applied to a laminate similar to that shown in FIG. 12, in the absence of the clear topcoat layer.

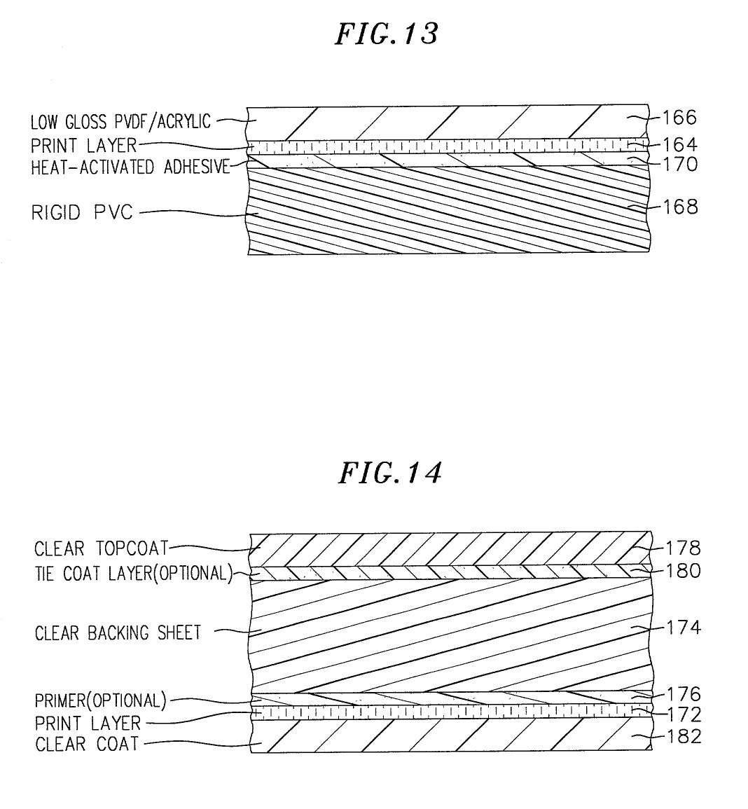

FIG. 13 illustrates a digitally printed low-gloss laminate which can be used for outdoor siding panels, for example. In this construction, a print layer 164 is applied to a low-gloss protective outer coat 166 which is supported on a temporary carrier (not shown) during the printing process. The print layer is applied to a rigid PVC backing sheet 168 with a heat-activated adhesive 170 following the print step.

FIG. 14 illustrates a digitally printed laminate in which a print layer 172 is reverse-printed on a clear backing sheet 174. This construction may include an optional primer coat 176 for bonding the print layer to the clear backing sheet. This construction also can include a clear topcoat 178 and an optional tie coat 180 for bonding to the backing sheet on a side opposite from the print layer. The clear topcoat may be needed to protect the clear backing sheet. A protective coating 182 may be optionally used for injection cladding applications to protect the reverse-printed layer. An alternative embodiment of the FIG. 14 structure can include the reverse-printed clear laminate without the clear topcoat layer 178.

FIG. 15 illustrates a digitally printed laminate having a thick, transparent topcoat 184. A print layer 186 is applied to a polymeric backing sheet 188 such as a white PVC sheet. The outer clear coat can be a thick urethane (approximately 40 mils) coat on the print layer. The urethane is a two-component system and is usually poured due to its thickness. The thick urethane layer produces a superior depth of image. The construction also can include an adhesive layer 190 such as a double-faced tape.

FIG. 16 illustrates a digitally printed laminate in which a protective clear coat 194 is applied with an ink jet printer. This construction includes an opaque polymeric backing sheet 198 and a print layer 192 applied either directly to the backing sheet or applied using a tie coat layer 196 for bonding the print layer to the backing sheet.

The embodiments illustrated herein can alternatively include clear topcoat layers which are either applied by the digital ink jet printer, or overlaminated, or applied by other methods of topcoat application such as roll coating or screen printing.

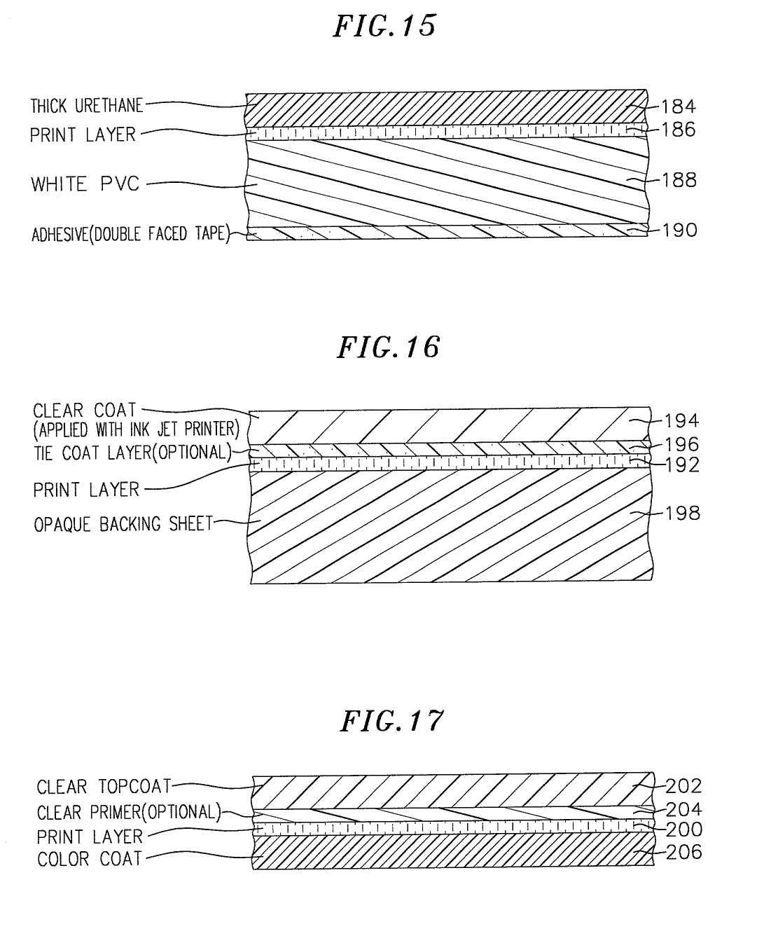

FIG. 17 illustrates a laminate which comprises an in-mold film which includes a print layer 200 printed on the underside of a clear topcoat layer 202 supported by a temporary carrier. An optional clear primer coat 204 bonds the print layer to the underside of the clear topcoat. Color coat layers 206 are then applied such as by solvent casting to the print layer. The laminate can be placed in an injection mold and the mold closed, and the resin from the molding material is injected behind the color coat layers to form a substrate. The mold is then opened, and a protective polyester carrier (not shown) which is on the clear topcoat is removed. The color coat layers provide extra opacity and provide protection for the print layer during the injection molding cycle.

### EXAMPLE 1

This example (and Examples 2 to 4) describe digital printing on a baseweb comprising a thin polymeric film supported by a temporary carrier and subsequently laminating the baseweb to an ABS backing sheet. A roll of 1.0 mil transparent PVC film, supported by a 1.0 mil high-gloss PET temporary carrier, was placed in an ink jet printer. Images were printed directly on the surface of the film, in the absence of an ink receptive layer on the baseweb. The film was heated to 120 deg. F. immediately before contact with the print head. The laminates and films of this invention are pre-heated prior to printing for improved ink adhesion. As presently understood, 120° F. is the minimum temperature needed for good adhesion. Several images of different colors were printed side-by-side on the PVC film. These images had previously been adjusted using software that changes such print quality factors as hue, contrast, lightness/darkness, saturation, resolution, and image size.

The ink jet printer was the Vutek 3360. The printed ink was from the Inkware line of organic solvent-based inks. The Vutek 3360 ink jet printer had a resolution of 360 dpi (dots per inch).

After the PVC film exited the print head, the film was heated in-line with an infrared heater. This again raised the film temperature to 120 deg. F., which facilitated solvent drying of the printed inks.

The film was printed at the rate of approximately 200 square feet per minute.

After the film was removed from the printer, it was tested for retained solvent. The retained solvent was 8.4%, which is comparable to a gravure printed sample of PVC film.

The printed film was then heat and pressure laminated to a 20 mil ABS backing sheet. The laminating drum pressure was 80 psi, the line speed was 25 fpm, and the drum temperature was 400 deg. F. The PET carrier was removed during the laminating step.

After laminating, the sheet was thermoformed to a three-dimensional shape at a sheet temperature of 330 deg. F. The gloss, color and DOI of the thermoformed sheet were visually comparable to a gravure printed product.

The thermoformed piece was trimmed, and placed in an injection mold, where an ABS substrate material was molded to the back of the laminate sheet.

The resulting injection molded part was tested in a Xenon Weatherometer. The test spec. used was SAE J1885. After 500 and 1240 kiloJoules exposure, the sample had retained its original gloss and DOI. (Gloss retention is considered comparable if at least 70% retention is produced for all accelerated weathering samples.) The color print quality of the resulting laminate was judged to be comparable to a gravure printed laminate.

In terms of gloss readings, this example (and Examples 2, 3 and 6 to 9, to follow) generally produced minimum gloss readings of 50 gloss units (measured on a 60 degree meter) for the high-gloss basewebs.

### EXAMPLE 2

A roll of 0.7 mil transparent urethane film, supported by a 1.0 mil high-gloss PET temporary carrier, was placed in an ink jet printer. The same printer, printing inks, printing rate, resolution, and images were used as in Example 1. The urethane film did not have an ink receptive layer. The urethane film was heated to 160 deg. F. immediately before contact with the print head. The higher film pre-heat temperature (as compared to Example 1) was found to give a better print appearance for the urethane.

The ink jet images were printed directly onto the film surface, and the film was again heated in-line with an infrared heater, to a film temperature of 120 deg. F, for solvent drying the printing inks.

After the film was removed from the printer, it was tested for retained solvent. The retained solvent was 8.8%, which is comparable to a gravure printed sample of urethane.

The same laminating, thermoforming, and injection molding steps were used as in Example 1.

The resulting injection molded part was tested in the Xenon Weatherometer, using the SAE J1885 test spec. After 500 and 1240 kiloJoules exposure, the sample had retained its original gloss and DOI.

### EXAMPLE 3

A roll of 1.8 mil transparent PVDF/acrylic film, supported by a 2.0 mil high-gloss PET temporary carrier, was placed in an ink jet printer. The same printer, printing inks, printing rate, film pre-heat temperature, infrared heating, resolution, and images were used as in Example 2. The film did not have an ink receptive layer.

After the film was removed from the printer, it was tested for retained solvent. The retained solvent was 2.9%, which is comparable to a gravure printed sample of PVDF/acrylic film.

The same laminating, thermoforming, and injection molding steps were used, as in Examples 1 and 2.

The resulting injection molded part was tested in the Xenon Weatherometer, using the SAE J1885 test spec. After 500 and 1240 kiloJoules exposure, the sample had retained its original gloss and DOI.

In addition, thermoformed (but not injection molded) samples were subjected to the following tests:

2000 hours QUV (ASTM G53 spec.)

2000 hours Xenon Weatherometer (SAE J1960 spec.)

500 hours Carbon Arc Weatherometer

72 hours water immersion at 70 deg. C.

At the conclusion of the water immersion test, the General Motors tape test GM 9071 was performed, and the sample passed. All of the samples in the accelerated weathering tests retained their original gloss and DOI.

### EXAMPLE 4

A roll of 0.7 mil translucent, low-gloss urethane film, supported by a matte 1.0 mil PET temporary carrier, was placed in an ink jet printer. The presence of a filler (fine particulate silica for example) in the urethane film acts as an agent to lower its gloss. The low-gloss film has a 60-degree gloss below about 10 gloss units. The same printer, inks, printing rate, film pre-heat temperature, infrared heating, resolution, and images were used as in Examples 2 and 3.

After the film was removed from the printer, it was tested for retained solvent. The retained solvent was 10.7%, which is comparable to a gravure printed sample of low-gloss urethane film.

The same laminating, thermoforming, and injection molding steps were used, as in Examples 1, 2 and 3.

The resulting injection molded part was tested in the Xenon Weatherometer, using the SAE J1885 test spec. After 500 and 1240 kiloJoules exposure, the sample was close to its original gloss and DOI. For the 500 kJ Xenon test, initial 60 degree gloss measured 8.1 gloss units; final 60 degree gloss measured 6.0 gloss units.

### EXAMPLE 5

This example describes digital printing directly on an ABS backing sheet. A roll of semirigid 10 mil opaque grey ABS sheet was placed in an ink jet printer. The same printer, printing inks, printing rate, resolution, infrared heating, and images were used as in Example 1. The ABS sheet did not have an ink receptive layer.

After the ABS sheet was removed from the printer, it was tape tested for ink adhesion. The test used was General Motors spec. GM 9071. No ink was removed during this test.

The printed ABS sheet was then thermoformed, using the same conditions as in Example 1.

After thermoforming, the GM 9071 test was again performed. The sample passed with no ink removal.

### EXAMPLE 6

This example describes printing directly on a transparent film. A roll of 1.8 mil transparent PVDF/acrylic film, supported by a 2.0 mil high-gloss PET temporary carrier, was placed in an ink jet printer. The same printer, inks, printing rate, film pre-heat temperature, infrared heating, resolution, and images were used as in Example 3.

The resulting film had the same retained solvent level as in Example 3.

The printed PVDF/acrylic film was laminated to a sheet of transparent 20 mil PETG. The resulting product had a translucent appearance, allowing a substantial amount of visible light through the laminate.

The laminating and thermoforming conditions were the same as in the previous Examples. The sample was not injection molded.

The resulting thermoformed part was tested in the QUV ultraviolet condensation tester for 2800 hours. The test method used was ASTM G53. After the 2800 hours exposure, the sample had retained its original gloss, color, and DOI.

### EXAMPLE 7

This example (and Example 8) describes use of different ink jet printers. A roll of 1.8 mil transparent PVDF/acrylic film, supported by a 2.0 mil high-gloss PET temporary carrier, was placed in an ink jet printer. The printer used this time was the Arizona, manufactured by Raster Graphics. Several images of different colors were printed side-by-side on the film. The resolution of these images was 300 dpi. The inks used were of the 3M Scotchcal Piezo Ink Jet Series 3700.

The film was printed at the rate of approximately 90 square feet per minute. Printing was directly onto the film surface, in the absence of an ink receptive layer.

The printed film was then laminated, thermoformed, and injection molded in the same manner as in Examples 1 through 4.

The resulting injection molded part was tested in the QUV ultraviolet condensation tester for 2800 hours. The test method used was ASTM G53. After the 2800 hour exposure, the sample had retained its original gloss, color, and DOI.

### EXAMPLE 8

A roll of 1.0 mil transparent PVC film, supported by a 1.0 mil high-gloss PET temporary carrier, was placed in a Roland Solvent Jet ink jet printer. Several images of different colors were printed side-by-side on the film. The resolution of these images was 1440 dpi. The inks used were of the Roland FPG series, printed with the CR-MR2 cartridges.

The film was printed at the rate of approximately 16 square feet per minute, and printing was directly onto the film surfaces.

The printed film was then laminated, thermoformed, and injection molded in the same manner as in Examples 1 through 4. Because of the higher resolution, these samples were judged to be superior in quality to gravure printed samples.

### EXAMPLE 9

This example describes printing on a clear baseweb followed by laminating to a TPO backing sheet. A roll of 1.8 mil transparent PVDF/acrylic film, supported by a 2.0 mil high-gloss PET temporary carrier, was processed with the same printing steps, and the same processing conditions, as in Example 3.

The printed film was then heat and pressure laminated to a white 20 mil TPO sheet. This TPO sheet had previously been laminated with a CPO/acrylic two-layer coating for improved adhesion. The printed side was laminated to the acrylic side of this two layer coating. The laminating drum pressure was 80 psi, the line speed was 25 fpm, and the drum temperature was 380 deg. F.

After laminating, the sheet was thermoformed at a sheet temperature of 320 deg. F. The gloss and DOI of the thermoformed sheet were comparable to a gravure printed product.

The thermoformed piece was trimmed, and placed in an injection mold, where a TPO substrate material was molded to the back of the laminate sheet.

The resulting injection molded part was tested in the Xenon Weatherometer. The test spec. used was SAE J1885. After 500 and 1240 kiloJoules exposure, the sample had retained its original gloss and DOI.

### EXAMPLE 10

This example describes digital printing on a TPO backing sheet. A roll of 20 mil opaque black TPO sheet was placed in an ink jet printer. This TPO sheet had previously been laminated with a CPO/acrylic two-layer coating for improved adhesion. The acrylic part of the two-layer coating was printed with the inks. The same printer, inks, printing rate, resolution, infrared heating, and images were used as in Example 1.

After the TPO sheet was removed from the printer it was tape tested for ink adhesion. The test used was GM9071. No ink was removed during this test.

The printed TPO sheet was then thermoformed, using the same conditions as in Example 9.

After thermoforming, the GM9071 test was again performed. The sample passed, with no ink removal.

### EXAMPLE 11

A roll of 20 mil opaque brown ABS sheet was placed in an ink jet printer. The same printer, inks, printing rate, resolution, infrared heating, and images were used, as in Example 1. Printing was directly onto the surface of the ABS sheet.

The ABS sheet was then removed from the printer. A piece of transparent 1.8 mil PVDF/acrylic film, supported by a 2.0 mil high-gloss PET temporary carrier, was laminated to the printed side. The laminating pressure was 80 psi, the line speed was 25 fpm, and the laminating drum temperature was 400 deg. F.

The laminate was then thermoformed and injection clad, using the same conditions of Example 1.

The resulting injection molded part was tested in the Xenon Weatherometer, using the SAE J1885 spec. After 500 and 1240 kiloJoules exposure, the sample had substantially retained its original gloss, color, and DOI. The appearance of this part was judged to be equal to the sample produced in Example 3. For the 1240 kJ Xenon test, initial 60 degree gloss measured 79.6; final 60 degree gloss measured 59.3.

### EXAMPLE 12

A roll of 20 mil opaque black TPO sheet was placed in an ink jet printer. This TPO sheet had previously been laminated with a CPO/acrylic two-layer coating for improved adhesion. The acrylic part of the two-layer coating was printed with the inks. The same printer, inks, printing rate, resolution, infrared heating, and images were used, as in Example 1.

The TPO sheet was then removed from the printer. A piece of 1.8 mil PVDF/acrylic film, supported by a 2.0 mil high-gloss PET temporary carrier, was laminated to the printed side. The laminating pressure was 80 psi, the line speed was 25 fpm, and the laminating drum temperature was 380 deg. F.

The laminate was then thermoformed and injection clad, using the same conditions of Example 9.

The resulting injection molded part was tested in the Xenon Weatherometer, using the SAE J1885 spec. After 500 and 1240 kiloJoules exposure, the sample had retained its original gloss, color, and DOI. The appearance of this part was judged to be equal to the sample produced in Example 9. For the 1240 kJ Xenon test initial 60 degree gloss measured 76.2; final 60 degree gloss measured 67.8.

### EXAMPLE 13

A roll of 20 mil clear PETG sheet was placed in an ink jet printer. The same printer, printing inks, printing rate, resolution, infrared heating, and images were used, as in Example 1. Printing was directly onto the PETG sheet, in the absence of an ink receptive layer.

The printed PETG sheet was thermoformed at a sheet temperature of 300 deg. F. The resulting thermoformed piece had gloss and DOI comparable to the (high-gloss baseweb) samples of Examples 1, 2, and 3. The PETG maintained its transparency after thermoforming. Due to the translucency of the ink jet print, the thermoformed piece had some visible light transmission.

### EXAMPLE 14

A roll of 3 mil opaque adhesive-backed PVC film was placed in an ink jet printer. Printing was directly onto the surface of the film. The PVC is commercially available from the Avery-Dennison Corp., and has the product number MPI 1005. The same printer, inks, printing rate, and resolution were used, as in Example 7. The PVC film was supported by a temporary carrier. The film was not pre-heated.

The resulting film was tested for ink adhesion, using the GM 9071 spec. No ink was removed during this test.

The film was then placed on a vacuum table. A two-component urethane, commercially available as Chem-Dec 829, was poured on the ink jet printed pattern, to a depth of 40 mils. The urethane was allowed to dry at room temperature for 24 hours, at which time it was considered fully cured.

The resulting product had a 20 deg. gloss of 60 and a DOI of 90. These readings were much higher than the other Examples, due to the greater thickness and clarity of the urethane.

What is claimed is:

1. A process for making a thermoformable digitally printed product which includes a flexible thermoformable polymeric baseweb, the process comprising passing the baseweb through an ink jet printer which is digitally controlled for applying a solvent-based (non-aqueous) digital printing ink in a multiple color format directly to the baseweb, in the absence of an ink receptive layer on the baseweb, to form a multiple-color decorative pattern on the baseweb in a single pass through the printer, followed by thermoforming and/or injection molding the printed baseweb to a three-dimensional shape.

2. The process according to claim 1 which includes overlaminating a protective weatherable polymeric clear coat layer to the printed surface of the baseweb prior to the thermoforming step.

3. The process according to claim 1 including a tie coat understamped on the baseweb, and in which the digital printing ink is applied to regions containing the tie coat for enhanced adhesion of the printed ink pattern to the baseweb.

4. The process according to claim 1 in which the baseweb comprises a polymeric film or sheet having a thickness from about 0.5 to about 40 mils.

5. The process according to claim 1 including applying a protective abrasion and UV resistant clear coat of a polymer different from the baseweb material over the decorative pattern digitally printed on the baseweb, using the digital ink jet printer to apply the clear coat.

6. The process according to claim 1 including maintaining the baseweb at an elevated temperature during the printing step, said temperature sufficient to improve ink adhesion compared to printing at ambient temperature.

7. The process according to claim 6 in which the baseweb is heated to a temperature in excess of about 120° F. before the printing step.

8. The process according to claim 7 including reheating the baseweb to a temperature in excess of about 120° F. following the printing step, to solvent dry the ink.

9. The process according to claim 2 in which the protective clear coat layer has a 60 degree gloss level in excess of about 50 gloss units before and after thermoforming.

10. The process according to claim 1 in which the baseweb comprises a flexible polymeric film having a thickness less than about 3 mils, supported on a temporary flexible high-gloss carrier sheet.

11. The process according to claim 10 including laminating the printed baseweb to a semirigid thermoformable polymeric backing sheet under heat and pressure to form a digitally printed laminate which is thermoformed or molded to said three-dimensional shape.

12. The process according to claim 11 in which 60 degree gloss of the finished laminate after the thermoforming or molding step is in excess of about 50 gloss units.

13. The process according to claim 1 in which the thermoformed baseweb passes the GM 9071 ink adhesion test.

14. The process according to claim 1 in which the thermoformed or molded baseweb, when tested according to the SAE J1885 Xenon Weatherometer test, substantially retains its original gloss.

15. The process according to claim 1 in which the thermoformed or molded baseweb, when tested according to the ASTM G53 QUV accelerated weather test, substantially retains its original gloss.

16. A process for making a thermoformable laminate comprising a semirigid thermoformable polymeric backing sheet having a thickness in the range of about one to about 40 mils, the process comprising passing the backing sheet through a digitally controlled ink jet printer; applying a solvent-based (non-aqueous) digital printing ink from the digitally-controlled ink jet printer directly to the backing sheet surface in the absence of an ink receptive layer on the sheet, to form a decorative pattern on the sheet in multiple colors in a single pass through the printer; and then thermoforming and/or injection molding the backing sheet to a three-dimensional shape.

17. The process according to claim 16 in which the thermoformed or molded sheet passes the GM 9071 ink adhesion test.

18. The process according to claim 16 in which the thermoformed or molded sheet, when tested according to the SAE J1885 Xenon Weatherometer test, substantially retains its original gloss.

19. The process according to claim 16 in which the thermoformed or molded sheet when tested according to the ASTM G53 QUV accelerated weather test, substantially retains its original gloss.

20. The process according to claim 16 including applying a protective polymeric outer clear coat over the printed surface of the backing sheet, followed by thermoforming the resulting laminate.

21. The process according to claim 20 in which the 60 gloss of the laminate before and after thermoforming is in excess of 50 gloss units.

22. The process according to claim 20 in which the thermoformed laminate passes the GM 9071 ink adhesion test.

23. The process according to claim 20 in which the thermoformed or molded laminate, when tested according to the SAE J1885 Xenon Weatherometer test, substantially retains its original gloss.

24. The process according to claim 20 in which the thermoformed or molded laminate, when tested according to the ASTM G53 QUV accelerated weather test, substantially retains its original gloss.

25. A process for making a thermoformable digitally printed laminate comprising the steps of:
providing a flexible or semirigid thermoformable baseweb having a thickness in the range of about 0.5 to about 40 mils; passing the baseweb through an ink jet printer which is digitally controlled for applying a solvent-based (non-aqueous) digital printing ink in a multiple color format directly to the baseweb, in the absence of an ink-receptive layer on the baseweb, to form a multiple-color decorative pattern on the baseweb in a single pass through the printer; the baseweb maintained at a temperature in excess of about 120° F. during the printing step; followed by thermoforming and/or injection molding the printed baseweb to a three-dimensional shape, the thermoformed printed baseweb having sufficient ink adhesion for passing the GM 9071 ink adhesion test.

26. The process according to claim 25 including forming a laminate from the printed baseweb, the laminate at least including a formable transparent protective topcoat layer, and thermoforming the laminate to a three-dimensional shape.

27. The process according to claim 26 in which the protective topcoat layer of the thermoformed laminate has a 60 degree gloss greater than about 50 gloss units.

28. The process according to claim 25 in which the thermoformed baseweb, when tested according to the SAE J1885 Xenon Weatherometer test, substantially retains its original gloss.

29. The process according to claim 25 in which the thermoformed baseweb, when tested according to the ASTM G53 QUV accelerated weather test, substantially retains its original gloss.

30. A process for making a thermoformable color-matched digitally printed product which includes the steps of:
producing a software-driven multiple color print pattern on a computer screen to represent a standard color print pattern of a digitally printed product; producing a thermoformable digitally-printed product which includes a flexible thermoformable polymeric baseweb, by the steps of passing the baseweb through an ink jet printer which is digitally controlled for applying a solvent-based (non-aqueous) digital printing ink in a multiple color format directly to the baseweb, in the absence of an ink-receptive layer on the baseweb, to form a multiple-color decorative pattern on the baseweb in a single pass through the printer;
the decorative pattern on the digitally-printed product having been color-matched to the multiple color print pattern of the standard color print pattern displayed on the computer screen.

31. The process according to claim 30 including thermoforming and/or injection molding the printed baseweb to form a finished product having a three-dimensional shape, in which print quality of the decorative pattern on the finished product is substantially comparable to the print pattern prior to the thermoforming step.

32. The process according to claim 30 including maintaining the baseweb at a temperature in excess of about 120° F. during the printing step.

33. The process for making a color matched thermoformable decorative laminate comprising producing a software-driven image of a pattern on a screen to represent a standard color print pattern; evaluating and adjusting the standard as displayed on the screen, using software-driven image-related adjustments; producing a test print by the steps of applying a decorative pattern to a flexible, semirigid, thermoformable polymeric backing sheet using digital printing ink applied by a digital ink jet printer; making an optional software-driven image-related adjustment to color match the test print image to the standard, and when the adjusted test print image is acceptable, passing an image-related output to the digital ink jet printer for printing on the backing sheet to produce a decorative print color matched to the accepted on-screen standard.
